(19) United States
(12) Patent Application Publication
(10) Pub. No.: US 2002/0181367 A1
(43) Pub. Date: Dec. 5, 2002

(54) Optical reading apparatus having aberration-correcting function

(75) Inventor: Masakazu Ogasawara, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/155,978

(22) Filed: May 29, 2002

(30) Foreign Application Priority Data
May 30, 2001 (JP) 2001-161985

(51) Int. Cl. G11B 7/135

(52) U.S. Cl. 369/53.19; 369/112.02

(57) ABSTRACT

An optical reading apparatus includes an objective lens for focusing an optical beam; an actuator for driving the objective lens; an aberration detector for detecting spherical and coma aberration of the optical beam; an aberration correction element, including a liquid crystal element, for correcting the spherical and coma aberration by applying voltages to the liquid crystal element; a lens location detector for detecting displacement of the objective lens with respect to a reference location; and a controller for controlling the amount of aberration correction of the aberration correction element in accordance with the spherical aberration, the coma aberration, and the displacement.

### BACKGROUND OF THE INVENTION

1. Field of the Invention

The present invention relates to an optical reading apparatus, and more particularly to an optical reading apparatus having a capability of correcting aberration generated in a light beam of an optical system.

2. Description of the Related Art

Among information recording media to and from which information is optically recorded and read, there are optical discs such as DVDs (digital versatile discs or digital video discs). There have been great efforts to increase the recording density of such optical discs as information communications technologies have advanced in recent years. Furthermore, high-performance optical pickup devices and information recording and reproducing devices are required in accordance with the progress of such high-density optical discs.

There is an approach to irradiate a light beam having a smaller irradiating diameter to the optical disc by increasing the numerical aperture (NA) of an objective lens provided in the optical pickup device so as to cope with the increase in recording density of the optical disc. Furthermore, the density of the optical disc can be increased by using a short wavelength optical beam.

However, aberration of the light beam caused by an optical disc is increased as the numerical aperture NA of the objective lens is increased or a light beam having a shorter wavelength is used. This makes it difficult to improve performance accuracy of the recording/reproduction of information.

In order to reduce the above-mentioned aberration effect, a pickup device equipped with a liquid crystal element for correcting aberration has been proposed. Such a liquid crystal element for correcting aberrations is disclosed, for example, in Japanese Unexamined Patent Application Publication Kokai No. 10-269611.

In a conventional aberration correction device using a liquid crystal unit, the liquid crystal unit is fixed to the objective lens and the liquid crystal unit is integrally driven together with the objective lens by an actuator. However, as the weight of the movable portion of the actuator increases, the sensitivity of the actuator is reduced and the high-order resonance frequencies are lowered. Accordingly, it is difficult to increase the servo-control bandwidth and double-speed recording/reproduction cannot be realized. Furthermore, the electrical wiring to the liquid crystal unit is complex, and there are other problems. On the other hand, when the liquid crystal unit is not integrally driven together with the objective lens, the performance for correcting spherical aberration is reduced since coma aberration is caused by displacement between the objective lens and the liquid crystal unit, and also there is a problem in that the dynamic range within which the aberration can be corrected is narrowed.

### OBJECT AND SUMMARY OF THE INVENTION

Accordingly, it is an object of the present invention to provide an optical reading apparatus having high aberration-correction performance in which an objective lens can be driven at high speed.

To achieve the object, according to one aspect of the present invention, there is provided an optical reading apparatus for reading information data recorded on a recording medium by irradiation with an optical beam, which comprises an objective lens for focusing the optical beam; an actuator for driving the objective lens; an aberration detector for detecting spherical aberration and coma aberration of the optical beam; an aberration correction element, including a liquid crystal element, for correcting the spherical aberration and the coma aberration of the optical beam by applying voltages to the liquid crystal element; a lens location detector for detecting displacement of the objective lens with respect to a reference location; and a controller for controlling the amount of aberration correction of the aberration correction element in accordance with the spherical aberration, the coma aberration, and the displacement.

According to another aspect of the present invention, there is provided an optical reading apparatus for reading information data recorded on a recording medium by irradiation with an optical beam, which comprises an objective lens for focusing the optical beam; an actuator for driving the objective lens; an aberration detector for detecting spherical aberration and coma aberration of the optical beam; an aberration correction element, including a liquid crystal element, for correcting the spherical aberration and the coma aberration of the optical beam by applying voltages to the liquid crystal element; a displacement detector for detecting displacement of the objective lens from the liquid crystal element; and a controller for controlling the amount of aberration correction of the aberration correction element in accordance with the spherical aberration, the coma aberration, and the displacement.

### BRIEF DESCRIPTION OF THE DRAWINGS

FIG. 1 is a block diagram showing the configuration of an optical reading apparatus having an aberration-correcting function of an embodiment of the present invention;

FIG. 2 shows the shift of an objective lens during a tracking operation and the amount of decentering D between an aberration correction unit and the objective lens;

FIG. 3 shows the residual aberration versus the decentering D after spherical aberration correction has performed;

FIG. 4 is a sectional view showing the configuration of the aberration correction unit having a spherical aberration correction electrode and a coma aberration correction electrode;

FIG. 5 is a top view showing the configuration of the spherical aberration correction electrode and the shape of transparent electrode;

FIG. 6 is a top view showing the configuration of the coma aberration correction electrode and the shape the transparent electrodes;

FIG. 7 is a flow chart showing the procedure for the aberration correction operation of the optical reading apparatus;

FIG. 8 is a flow chart showing the procedure for spherical aberration correction;

FIG. 9 is a flow chart showing the procedure for decentering correction; and

FIG. 10 shows the effect of aberration correction when the aberration correction control has been performed, which corresponds to that in FIG. 3.

### DESCRIPTION OF THE PREFERRED EMBODIMENT

The embodiments of the present invention are described in detail with reference to the drawings. Furthermore, the same reference numerals are given to substantially equivalent components in the drawings.

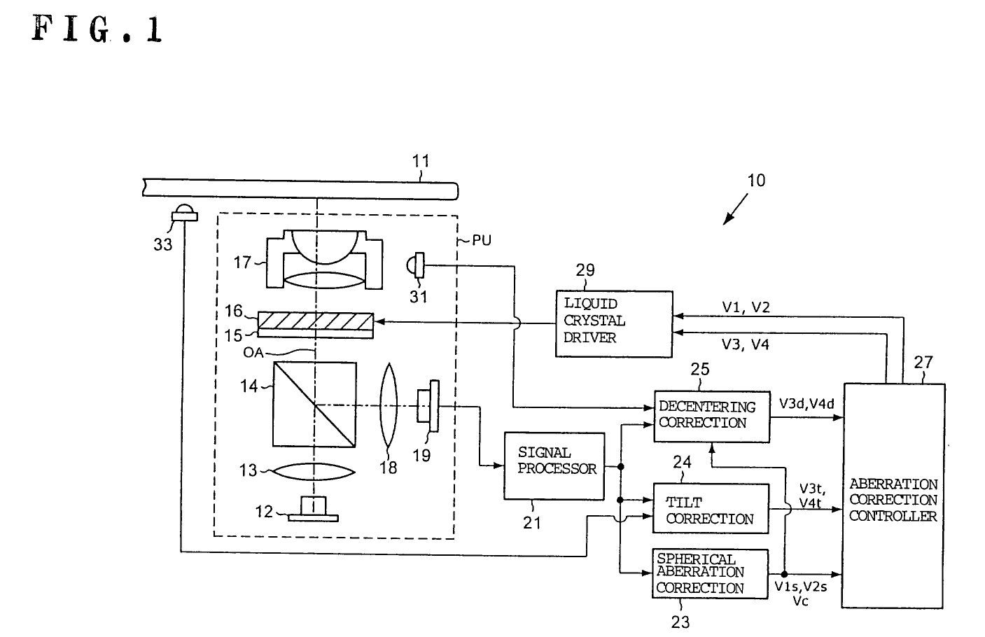

FIG. 1 is a block diagram showing the configuration of an optical reading apparatus 10 having a capability of correcting aberration according to an embodiment of the present invention.

A laser light source 12 provided in an optical pickup PU emits laser light having a wavelength λ of 405 nm, for example. The light beam emitted from the laser light source 12 is made into a parallel light beam by a collimating lens 13. The light beam, after passing through a beam splitter 14, a quarter-wave plate 15, and an aberration correcting unit 16, is condensed by an objective lens 17 and is focused on an information recording surface of an optical disc 11. The optical beam reflected by the optical disc 11 is then condensed by the objective lens 17 to pass through the aberration correction unit 16, the quarter-wave plate 15, the beam splitter 14, and the condensing lens 18, and then is detected by an optical detector 19.

A read signal (RF signal) detected by the optical detector 19 is sent to a signal processing unit 21. The signal processing unit 21 generates a signal required to control the aberration control unit 16 in accordance with the received RF signal and supplies the signal to a spherical aberration correction controller 23, a tilt correction controller 24, and a decentering correction controller 25. More particularly, the signal processing unit 21 extracts signals such as prepit signals or the envelope amplitude of read signals, etc., and supplies the signals to the controllers 23, 24, and 25.

The spherical aberration correction controller 23 generates a voltage for correcting spherical aberration in accordance with an envelope amplitude signal to supply the voltage to an aberration correction controller 27.

The tilt correction controller 24 receives a signal from a tilt sensor 33 and the envelope amplitude signal. The tilt sensor 33 generates a tilt signal in accordance with the tilt angle of the optical disc 11. The tilt correction controller 24 generates a voltage for correcting aberrations caused by tilting of the optical disc 11 in accordance with the envelope amplitude signal and the tilt signal to supply the voltage to the aberration correction controller 27.

The decentering correction controller 25 generates a decentering correction voltage in accordance with the envelope amplitude signal, a signal from an objective lens location sensor 31, and the spherical aberration correction voltage signal from the spherical aberration collection controller 23 and supplies the decentering correction voltage to the aberration correction controller 27. Furthermore, the objective lens location sensor 31 generates a signal in accordance with the location of the objective lens 17 or a signal in accordance with the amount of decentering (hereinafter, simply referred to as “decentering”), i.e., amount of deviation or displacement from a center, as the deviation from a reference position such as the optical axis OA of the aberration correction unit 16. Alternatively, the driving current of an actuator (not shown) which moves the objective lens 17 may be used instead of the objective lens location sensor 31.

The aberration correction controller 27 sends a driving signal to a liquid crystal driver 29, which drives the aberration correction unit 16, in response to the signals supplied from the controllers 23, 24, and 25, to perform aberration correction control of the aberration correction unit 16. The controllers 23, 24, 25, and 27 serves as a controller of the whole optical reading apparatus 10.

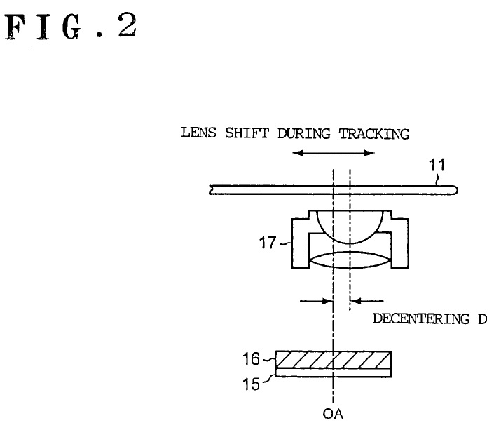

Then, the displacement between the aberration correction unit 16 and the objective lens 17 will be described. As shown in FIG. 2, a displacement is caused between the optical axis of the aberration correction unit 16 and the optical axis of the objective lens 17 in the optical pickup PU during the tracking or tracing operation. The displacement is mainly produced such that the objective lens 17 follows the decentered optical disc 11 (for example, by the amount of about 100 μm). Since spherical aberration correction is performed, coma aberration is dominant when such a displacement takes place. The degree of coma aberration is dependent on the amount of spherical aberration correction and the amount of displacement (i.e., decentering D).

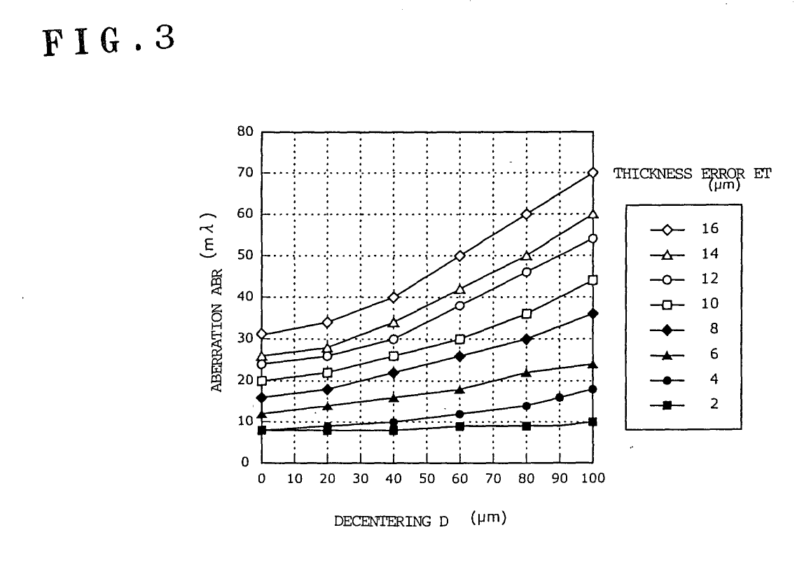

The spherical aberration is caused by the thickness distribution of a transparent cover layer through which the light beam from the objective lens 17 passes through. In FIG. 3, the root-mean-square value ABR (x 10⁻³ λ) of the residual aberration versus the decentering D is shown when the spherical aberration is corrected. In this graph, the specified parameter is thickness error ET (μm), which is the deviation from the center value of thickness of the cover layer. As the decentering D increases, the aberration ABR increases, but most of the aberration is coma aberration. Since the direction of the coma aberration caused by the displacement is the same as the direction of the coma aberration by radial tilting of the disc, the aberration correction electrode for correcting the radial tilt of the disc can also be used for aberration correction caused by the displacement.

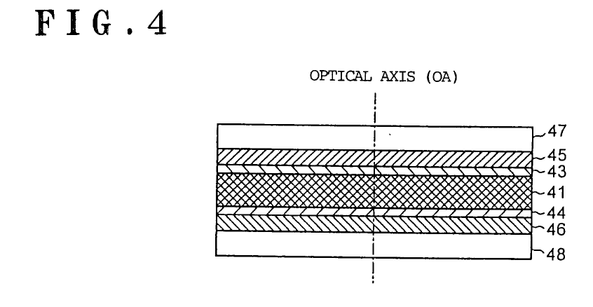

FIG. 4 is a sectional view showing the configuration of an aberration correction unit 16 having both a spherical aberration correction electrode and a coma aberration correction electrode. The aberration correction unit 16 includes a liquid crystal element 41, exhibiting an electro-optical effect, sandwiched between the spherical aberration correction electrode and the coma aberration correction electrode. In more detail, a liquid crystal orientation film 43, a spherical aberration correction electrode 45, and a glass substrate 47 are formed on one side of the liquid crystal element 41. Furthermore, a liquid crystal orientation film 44, a coma aberration correction electrode 46, and a glass substrate 48 are formed on the other side of the liquid crystal element 41.

When a driving voltage is applied to each of the electrodes 45 and 46 of the aberration correction unit 16 having such a configuration, the orientation of the molecules of the liquid crystal is changed in accordance with the electric field produced by the applied voltage. In this manner, the refractive index distribution in a plane perpendicular to the travelling direction of a light beam passing through the aberration correction unit 16 can be arbitrarily adjusted, and the phase of the wavefront of the optical beam can be independently controlled in each of the divided areas of the electrodes 45 and 46.

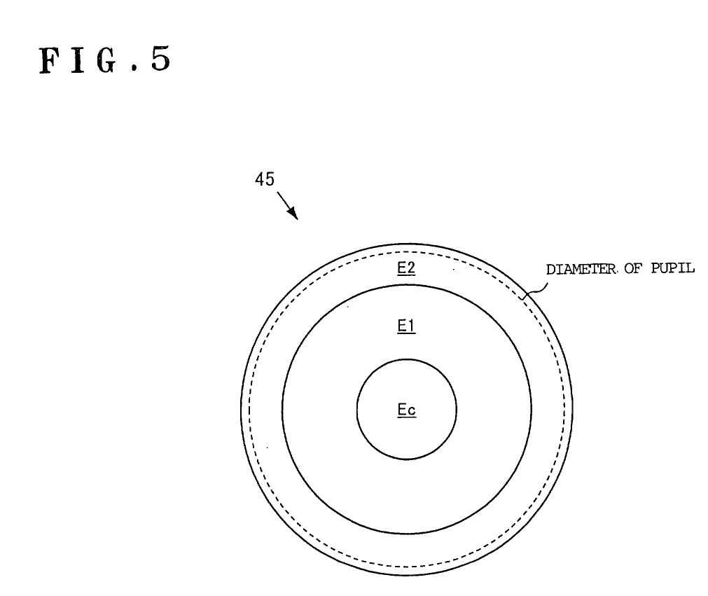

FIG. 5 is a plan view illustrating the configuration of the spherical aberration correction electrode 45. The spherical aberration correction electrode 45 includes transparent electrodes Ec, E1, and E2 which are concentrically formed on a surface perpendicular to the optical axis OA by using a transparent conductor such as an ITO (indium tin oxide) film. Electrode-separating spaces (not illustrated) are provided between the transparent electrodes Ec, E1, and E2, and the transparent electrodes are electrically isolated from one another.

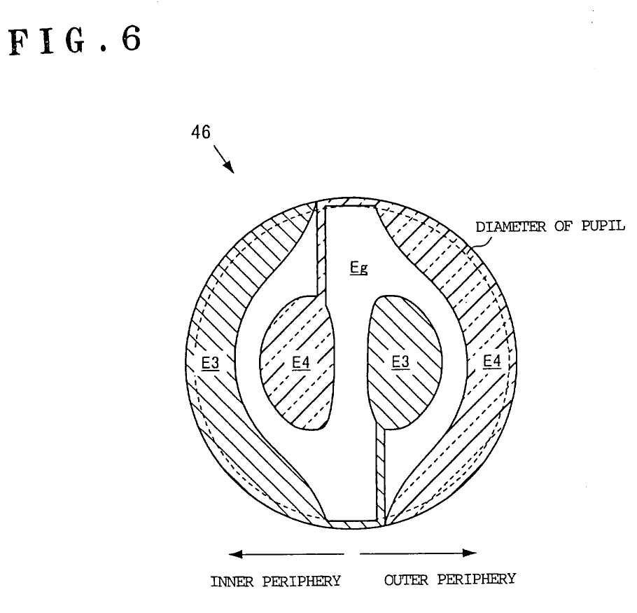

FIG. 6 is a plan view showing the configuration of a coma aberration correction electrode 46. The coma aberration correction electrode 46, in which a transparent conductor such as an ITO film is used, includes transparent electrodes Eg, E3, and E4 formed in accordance with the distribution of coma aberration produced in the optical beam in a plane perpendicular to the optical axis OA. More particularly, the shape of the transparent electrodes is substantially symmetrical with respect to the tracing direction of the optical disc 11, i.e., the tangential direction. Electrode-separating spaces (not illustrated) are provided between the transparent electrodes Eg, E3, and E4, and the transparent electrodes are electrically isolated from one another. Therefore, a voltage can be independently applied to each electrode, and the phase of an optical beam passing through the aberration correction unit 16 can be controlled in accordance with the amount of applied voltage.

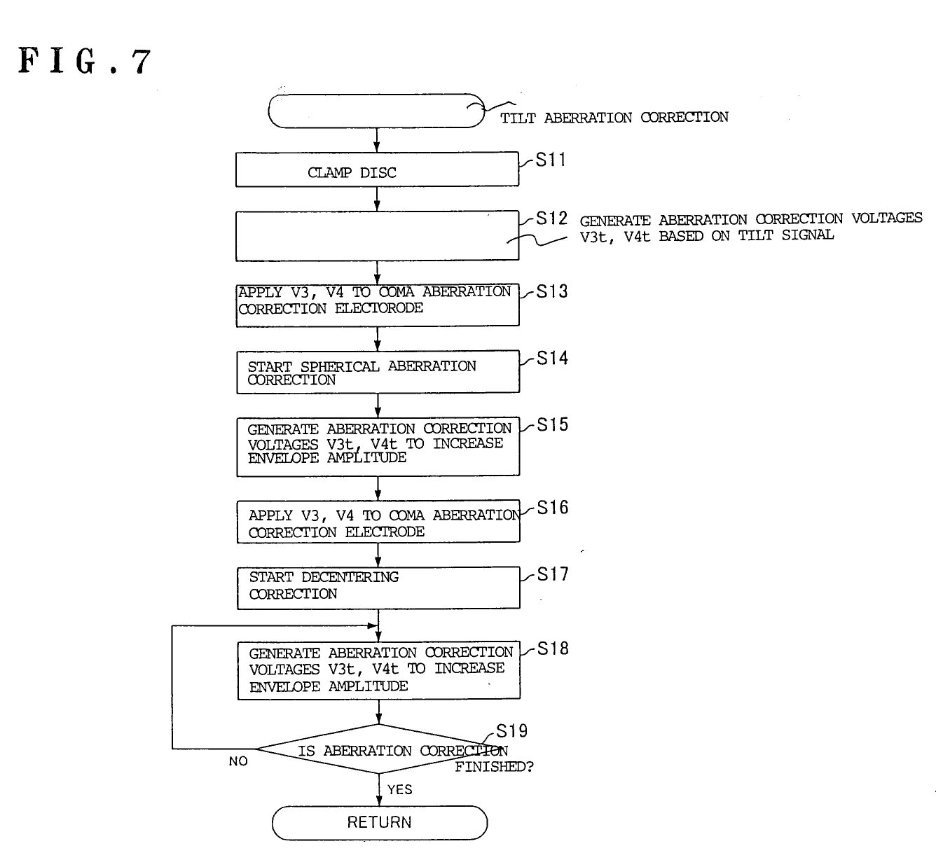

Then, the procedure for the aberration correction operation of the optical reading apparatus 10 is described in detail with reference to the flow charts shown in FIGS. 7 to 9. Furthermore, hereinafter, the applied voltages corresponding to the transparent electrodes Ec, Eg, and E1 to E4 of the spherical aberration correction electrode 45 and the coma aberration correction electrode 46 are described as Vc, Vg, and V1 to V4, respectively.

First of all, after an optical disc 11 has been clamped (step S11), correction voltages V3t and V4t (hereinafter, referred to as tilt aberration correction voltages) required for correcting aberration caused by tilting on the basis of a tilt signal from the tilt sensor 33 are determined and generated in the tilt correction controller 24 (step S12) as shown in FIG. 7. The tilt aberration correction voltages V3t, V4t are supplied to the aberration correction controller 27. The aberration correction controller 27 applies the tilt aberration correction voltages V3t, V4t to each of the transparent electrodes E3, E4 of the coma aberration correction electrode 46 as the coma aberration correction voltages V3 and V4 through the liquid crystal driver 29 (step S13). The transparent electrode Eg is grounded (i.e., Vg=0). Correction (rough adjustment) of the aberrations caused by radial tilting is performed by application of the correction voltage.

Then, spherical aberration correction, which will be described in detail later, is started (step S14). The aberration correction voltages V3t, V4t are generated so as to increase the envelope amplitude while performing the spherical aberration correction (step S15). More particularly, the tilt correction controller 24 fluctuates or wobbles the aberration correction voltages to calculate change amounts of the aberration correction voltages in accordance with the direction (i.e., to increase or decrease) of change of the envelope amplitude and the amount of change of the envelope amplitude. The aberration correction controller 27 applies the tilt aberration correction voltages V3t, V4t as the coma aberration correction voltages V3 and V4 to the coma aberration correction electrode 46 (step S16). The change amounts of the aberration correction voltages are calculated such that the aberration correction is optimized by repeating such procedures for each change. Such procedures can be performed based on various optimizing methods generally used.

Then, a decentering correction, which will be described in detail later, is started (step S17). The decentering correction is performed and the aberration correction voltages V3t, V4t are generated to increase the envelope amplitude. Then, a determination of whether or not the aberration correction control has been completed (step S19). When the aberration correction is finished, control quits the present routine. When the aberration correction control should be continued, control returns to step S18, and correction (fine adjustment) of the aberrations caused by radial tilting is performed by repeating the above-mentioned procedure. Furthermore, the tilt aberration correction voltages V3t, V4t generated in step S18 are used to correct coma aberration in a decentering correction routine to be described later.

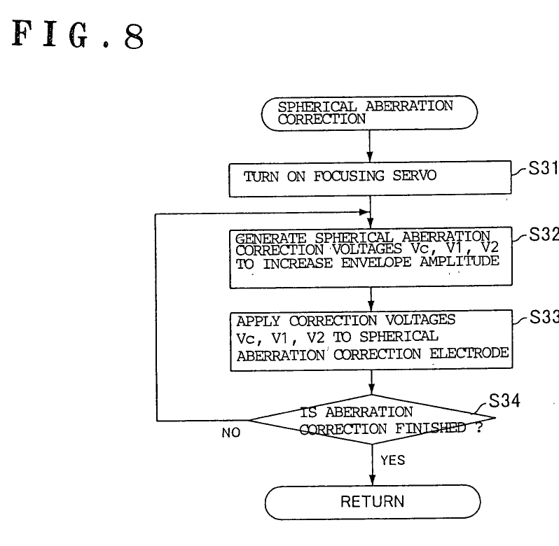

The above-mentioned spherical aberration correction operation is described with reference to FIG. 8. As shown in FIG. 8, focusing servo control is performed (step S31). The spherical aberration correction controller 23 determines and produces spherical aberration correction voltages Vc, V1, and V2 on the basis of the envelope amplitude signal from the signal processing circuit 21 (step S32). More particularly, the spherical aberration correction controller 23 fluctuates the aberration correction voltages and calculates the change amount of the aberration correction voltages to determine the spherical aberration correction voltages Vc, V1, and V2. The aberration correction controller 27 applies the spherical aberration correction voltages Vc, V1, and V2 to the respective transparent electrodes Ec, E1, and E2 of the spherical aberration correction electrode 45 (step S33). The spherical aberration correction is performed by applying the spherical aberration correction voltages.

Then, it is determined whether or not the aberration correction control is finished (step S34). When the aberration correction control is finished, control quits the present routine. When it is determined that the aberration correction should be continued, the procedure goes back to step S32 and the above processes are repeated. The spherical aberration correction is optimized by repeating the aberration correction and the amount of spherical aberration correction is kept close to the optimum. Furthermore, as described above, such spherical aberration correcting operation is simultaneously carried out in parallel with the coma aberration correcting operation (i.e., tilt aberration and decentering aberration).

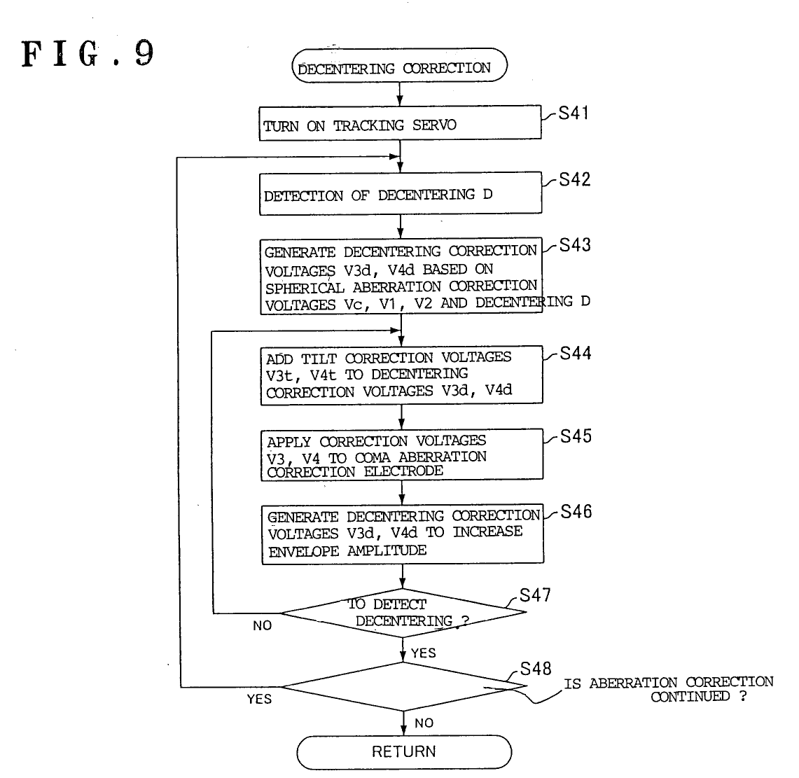

Then, the decentering correction operation is described with reference to FIG. 9. As shown in FIG. 9, tracking servo control is performed (step S41). The decentering D is detected by the objective lens location sensor 31 (step S42). Decentering correction voltages V3d and V4d are generated in a decentering correction controller in accordance with the decentering D and spherical aberration correction voltages Vc, V1, and V2 from the spherical aberration correction controller 23 (step S43). The aberration correction controller 27 adds the aberration correction voltages V3t, V4t from the tilt correction controller 24 and the aberration correction voltages V3d, V4d from the decentering correction controller (step S44), and the addition voltages are applied as the coma aberration correction voltages V3 and V4 to the respective transparent electrodes E3, E4 of the coma aberration correction electrode 46 in step S45. Rough adjustment in the correction of decentering is performed by the application of the correction voltages.

Then, fine adjustment in the correction of decentering is performed, more particularly, decentering correction voltages V3d, V4d are generated so as to increase the envelope amplitude (step S46). It is determined whether or not the decentering D is detected (step S47). The detection of the decentering D may be appropriately performed in accordance with the design of the aberration correction control. The detection of the decentering D may be designed, for example, with fixed timing or depending on the type of the optical disc used, the performance of optical systems and actuators to be used, etc. When it is determined in step S47 that the decentering D should not be detected, the procedure after step S44 is repeated. In this way, fine adjustment of the decentering correction is performed. On the other hand, when it is determined that the decentering D will be detected, it is further determined whether or not the aberration correction control should be continued (step S48). When it is determined that the aberration correction control should be continued, the routine goes back to step S42 and the above procedures are repeated. When the aberration correction control is finished, control quits the present routine.

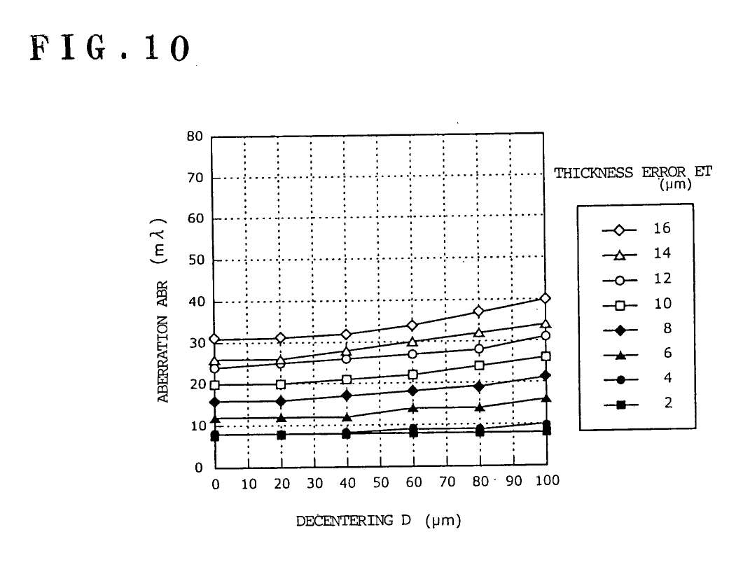

FIG. 10 shows the effect of aberration correction when the above-mentioned aberration correction control is performed. It can be understood that the residual aberration is greatly reduced when compared with the case wherein the aberration correction control is not performed, which is shown in FIG. 3.

As described in detail, according to the optical reading apparatus of the present invention, the spherical aberration caused by thickness error of the cover layer, the coma aberration due to disc tilting, and the coma aberration produced by displacement of the objective lens can be corrected by using a single aberration correction liquid crystal unit. The high-order resonance frequencies of the actuator for driving the objective lens can be made higher since the objective lens can be driven independently of the aberration correction unit. Accordingly, it is possible to achieve increased performance of, for example, a double-speed optical disc drive. Furthermore, the above-mentioned problem of wiring to the aberration correction unit can be solved.

It should be noted that the procedures for the aberration correction including the spherical aberration correction, tilt correction, and decentering correction shown in the above embodiment are only illustrative. The procedures may be performed simultaneously in parallel with or one after another in order to properly carry out the aberration correction.

Furthermore, in the above-described embodiment, although the case where the envelope amplitude signal is used for aberration correction signal is described as an example, various characteristic values of the detection signal from the optical detector can be used. For example, control may be performed such that a prepit signal, jitters, or a bit-error-rate of the read signal become optimal. Furthermore, a detection signal from the optical detector, for example, a radial push-pull signal or a tracking error signal may be used instead of using the objective lens location sensor and the tilt sensor as described above.

Furthermore, in the above-described embodiment, the controlling function is described as separate circuit blocks, i.e., controllers 23 to 25 and 27, however, the controlling function may be provided as a microprocessor (CPU), software, a firmware, or a combination of these.

Furthermore, although an optical reading apparatus used in an optical pickup device for optical discs has been described as an example, the optical reading apparatus of the present invention can be applied to a device for correcting aberration in various optical systems. Furthermore, the figures shown in the above embodiment have been described as an example. The above embodiment may be appropriately modified and used in combination.

As described above in detail, according to the present invention, an optical reading apparatus having high aberration-correction performance can be provided. The objective lens in the apparatus can be driven at high speed.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No. 2001-161985 which is hereby incorporated by reference.

What is claimed is:

1. An optical reading apparatus for reading information data recorded on a recording medium by irradiation with an optical beam, comprising:
an objective lens for focusing the optical beam;
an actuator for driving said objective lens;
an aberration detector for detecting spherical aberration and coma aberration of the optical beam;
an aberration correction element, including a liquid crystal element, for correcting the spherical aberration and the coma aberration of the optical beam by applying voltages to said liquid crystal element;
a lens location detector for detecting displacement of said objective lens with respect to a reference location; and
a controller for controlling the amount of aberration correction of said aberration correction element in accordance with the spherical aberration, the coma aberration, and the displacement.

2. An optical reading apparatus according to claim 1, wherein said controller controls the correction amount for the coma aberration on the basis of the correction amount of the displacement and the spherical aberration.

3. An optical reading apparatus according to claim 1, wherein said aberration correction element is sandwiched between first and second electrodes for applying voltages to said liquid crystal element, wherein said first electrode has a shape for correcting the spherical aberration, and wherein said second electrode has a shape for correcting the coma aberration.

4. An optical reading apparatus according to claim 1, further comprising a tilt error detector for detecting a tilt error of said recording medium, wherein said controller controls the correction amount of the coma aberration in accordance with the tilt error.

5. An optical reading apparatus according to claim 1, wherein said lens location detector detects the displacement in accordance with a driving signal of the actuator.

6. An optical reading apparatus for reading information data recorded on a recording medium by irradiation with an optical beam, comprising:
an objective lens for focusing the optical beam;
an actuator for driving said objective lens;
an aberration detector for detecting spherical aberration and coma aberration of the optical beam;
an aberration correction element, including a liquid crystal element, for correcting the spherical aberration and the coma aberration of the optical beam by applying voltages to said liquid crystal element;
a displacement detector for detecting displacement of said objective lens from said liquid crystal element; and
a controller for controlling the amount of aberration correction of said aberration correction element in accordance with the spherical aberration, the coma aberration, and the displacement.

7. An optical reading apparatus according to claim 6, wherein said controller controls the correction amount for the coma aberration on the basis of the displacement.

8. An optical reading apparatus according to claim 6, further comprising a tilt error detector for detecting a tilt error of said recording medium, wherein said controller controls the correction amount of the coma aberration in accordance with the tilt error.
